(19) United States
(12) Patent Application Publication
(10) Pub. No.: US 2002/0138306 A1
(43) Pub. Date: Sep. 26, 2002

(54) System and method for electronically managing medical information

(76) Inventor: John Sabovich, Long Beach, CA (US)

Correspondence Address: LYON & LYON LLP, 633 WEST FIFTH STREET, SUITE 4700, LOS ANGELES, CA, 90071, US

(21) Appl. No.: 09/816,597

(22) Filed: Mar. 23, 2001

(51) Int. Cl. G06F 17/60

(52) U.S. Cl. 705/3

(57) ABSTRACT

An online occupational medicine management system and method that allow authorized physicians, patients, employers, and insurance companies to capture, store, retrieve, and disseminate an employee's medical records from any computer having Internet access. The employee medical information can be shared between the aforementioned parties in real time, resulting in improved quality of care and greater efficiency in the field of work-related injuries, i.e., workers' compensation. The online occupational medicine management system also provides physicians with diagnosis appropriate treatment protocols that can be pre-approved by a patient's employer and/or the employer's insurance company, thus requiring monitoring only of medical treatments that fall outside of the pre-approved protocols. Accordingly, administrative costs to insurance companies and employers are lessened, and payment time to physicians is reduced.

### 1. FIELD OF THE INVENTION

The present invention relates to electronically managing medical information, and more specifically, to a system and method by which employee medical information may be shared online in real time between physicians, patients, employers, insurance companies and/or other entities involved in the treatment, tracking or payment of medical services.

### 2. BACKGROUND OF THE INVENTION

Traditionally, the healthcare industry has used outdated technology for recording, maintaining and tracking medical information such as a physician's medical summary of a patient's visit, the physician's billing, the insurance company's payment, etc. While many other industries have moved to electronic-based technology for their recording and tracking purposes, particularly on the Internet, systems and methods used by the healthcare industry have remained largely paper-based. Other industries besides the healthcare industry have also remained with paper-based systems of record creation, maintenance and tracking.

As a result, the recording and tracking of information in the healthcare and certain other industries is highly inefficient, is plagued with over-utilization, duplication and high administrative costs, and suffers due to a lack of quality assurance and continuity of care. Moreover, the healthcare industry is inundated with excessive paperwork, and is mired in complex and outmoded billing and collection systems. And in government mandated programs such as worker's compensation, excessive paperwork is essentially a foregone result.

Recently, some technological advances in recording and tracking information have been made in the healthcare field. For example, U.S. Pat. No. 5,974,389 to Clark et al. discloses a medical record management system that allows caregivers and administrators to view patients' files electronically from different computer terminals, as opposed to the traditional method of viewing files on paper. Also, several systems have been disclosed that allow for the electronic transmission of patient information from caregivers in one location to caregivers in another location, such as from a hospital to a physician's office.

While these advances involving electronic transmissions have provided some advantages over paper-based records, they have not gained widespread acceptance in the medical profession generally because they are too cumbersome to efficiently use. More importantly, they do not provide access to patient records to individuals or entities outside the medical community such as insurance companies or administrative bodies such as those that exist in the worker's compensation field.

More specifically, current electronic systems provide access to patient records only to doctors, nurses and hospital/clinic administrative staff. None of the current electronic systems provide online access to employee medical records for non-medical personnel involved in the healthcare field such as work-related injuries, e.g., workers' compensation. On the contrary, these current electronic systems focus broadly on general health care, and do not address the problems plaguing the workers' compensation industry.

The workers' compensation industry has historically been very inefficient at handling work-related injury claims. As a result, many shortcomings exist that have affected the various entities involved in the workers' compensation field.

For example, employers are frequently unaware of the physical status of their injured employees, i.e., whether such employees are physically fit to work or not. And in general, the use of paper records to track an employee's medical condition may very well have obsolete information. Thus, employers cannot readily ascertain the amount of manpower available to them for a given job or project. This situation may be exacerbated for self-insured employers that are more susceptible to fraudulent injury claims by their employees.

As another example, employees are frequently subjected to less than satisfactory medical care and are greatly limited in the number of clinics or other medical facility at which they may receive medical treatment. To this end, injured employees are very often forced to visit a clinic near their places of employment, and do not have the option to visit a clinic closer to their homes.

As another example, insurance companies incur significant expenses overseeing and ensuring that reasonable treatment protocols are followed. Even then, insurance companies are susceptible to fraudulent injury claims by employees of the employers that they insure. This increases insurance costs which in turn generally increases healthcare costs.

As another example, doctors spend considerable time producing and reviewing charts, and often maintain inefficient billing departments. As a result, the billing process in the workers' compensation industry tends to be time-consuming and inaccurate, which adversely affects employers, insurance companies and doctors alike.

To remedy these problems, it would be advantageous to have an electronic online management system and method that provides employee medical information in real time to physicians, patients, employers, insurance companies and other individuals and/or entities involved in the field of work-related injuries.

### 3. SUMMARY OF THE INVENTION

The present invention is generally directed to an online medical management system and method that allows authorized physicians, patients, employers, insurance companies and other individuals and/or entities to capture, store, retrieve and disseminate employee medical records from any computer having access to the Internet or other pertinent network. The system and method of the current invention are particularly suited for the worker's compensation or occupational health field. The system and method of the current invention thus reduces operating and liability costs for insurance companies, employers and doctors, and increases efficiency, and continuity of care and quality assurance in the worker's compensation industry.

The current invention provides that employee medical information may be shared between the aforementioned parties in real time, resulting in improved quality of care and greater efficiency.

The online medical management system also provides physicians with appropriate, pre-approved protocols for treatment and diagnosis. These protocols may be pre-approved by a patient's employer, the employer's insurance company and/or other appropriate entity. This provides efficiency and a reduction in effort in monitoring treatment since only medical treatments that fall outside of the pre-approved protocols may need to be monitored. This also results in the automation of a substantial portion of the medical claims submitted to insurance companies for payment. Providing pre-approved treatment protocols also helps increases the quality of healthcare.

The system and method of the current invention also allows employers and insurance companies to more easily identify fraudulent injury claims due to their ability to access employee medical records online at any time, subject to access and security restrictions. Accordingly, administrative costs to insurance companies and employers are lessened, and payment time to physicians is reduced. Consequently, a built in administrative quality assurance plan is provided, and quality of care is improved.

The current invention is also directed to software that provides the foregoing. The current invention is also directed to business methods and method of generating revenue that are associated with the medical information management system and method.

### 4. BRIEF DESCRIPTION OF THE DRAWINGS

FIG. 1 is a schematic diagram of the online medical information management system of the current invention according to a preferred embodiment.

FIG. 2 is a flowchart illustrating a preferred method of utilizing the online medical information management system of FIG. 1.

FIG. 3a is a sample summary report for an employer showing a monthly breakdown of health-related information.

FIG. 3b is a sample report regarding showing an injury activity summary, as a subset of FIG. 3a.

FIG. 3c is a sample report regarding work status that may be provided by the system of the current invention, as a subset of FIG. 3b.

FIG. 4 shows a method of generating revenue regarding a physician in connection with the current invention.

FIG. 5 shows a method of generating revenue regarding a physician and system coordinator in connection with the current invention.

FIG. 6 shows a preferred structure of the software of the current invention.

FIG. 7 shows architecture for user interfaces.

FIG. 8 shows a sample business model as input in the software of the current' invention.

FIG. 9 shows tables and fields for a relational database for data inputted in the software of the current invention.

FIG. 10 shows the interactivity between the coordinator's database and users of the system of the current invention.

FIG. 11 shows a method generating revenue regarding a physician and system coordinator in connection with the current invention.

### 5. DETAILED DESCRIPTION OF THE PREFERRED EMBODIMENTS

The current invention generally provides a system and method for the electronic creation, revision, maintenance and tracking of information. The current invention also provides access to this information to the individuals and entities that are involved. To this end, the information may be provided in various reports in useful formats.

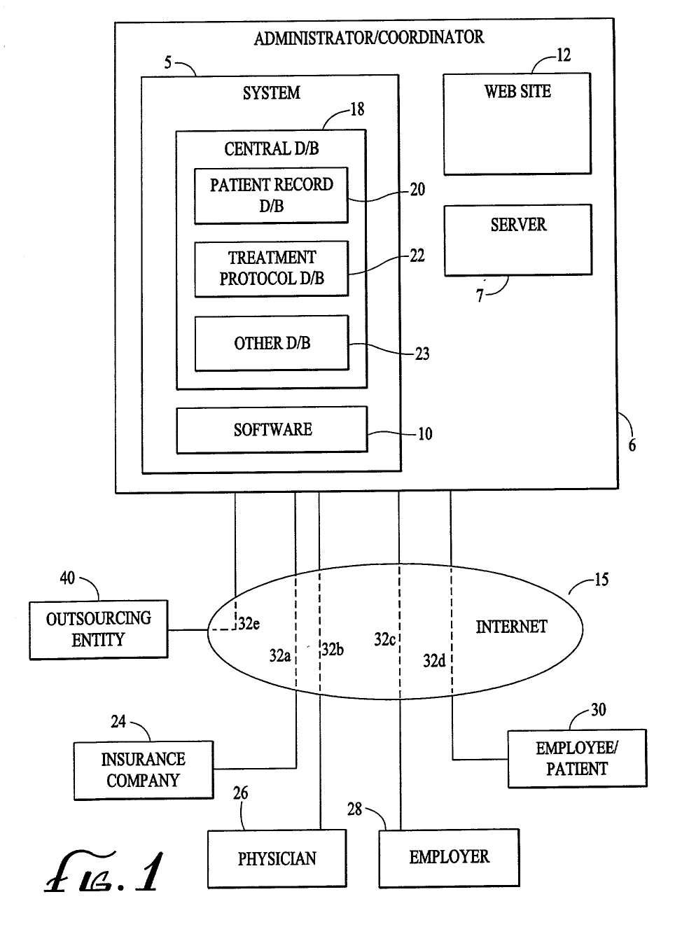

FIG. 1 illustrates a preferred embodiment of an electronic information management system (and associated method) 5 of the current invention as applied to the worker's compensation or occupational healthcare field. In this embodiment, electronic medical records of patients are created and stored in system 5. This information may be electronically accessed by the entities using system 5 such as patient 30, employer 28, insurance company 24 and/or physician 26.

System 5 may be used to update the electronic medical records to reflect events as a worker's compensation claim proceeds from the initial injury through the end of treatment and the patient's return to work. Furthermore, system 5 may provide reports in different formats that are useful to the pertinent users, e.g., reports that may be generated to recognize trends in healthcare, identify fraudulent worker's compensation claims, etc. Still further, system 5 may provide billing and other administrative tools.

It is believed that the current invention is particularly suitable to the field of worker's compensation because worker's compensation laws generally require employers to provide and pay for employee healthcare if the employee is injured on the job. So because the employer costs associated with worker's compensation are a given, it is believed that the system will be readily adopted by employers in worker's compensation claims in order to reduce costs. Furthermore, the systems and methods used to track employee healthcare are typically outdated as noted above in the background section. This is because many clinics that treat worker's compensation patients are generally behind the technology curve. Accordingly, it is believed that physician's and clinics will readily adopt system 5 to reduce costs and effort by using new technology.

In any event, it should be noted that the current invention is generally suitable to any application whereby a plurality of individuals or entities need to track information through various phases of it being processed. Accordingly, the current invention is not limited to the worker's compensation or healthcare field.

As shown in FIG. 1, system 5 (and its associated method of use) may be provided and maintained by a system administrator or coordinator 6. Coordinator 6 generally serves to coordinate the flow of information between the different entities involved. Coordinator 6 may maintain a web site 12 (that may be accessible on private or public communication networks) that contains system 5. Various users may access system 5, which in the worker's compensation application, may include insurance company 24, physician 26, employer 28 and patient/employee 30. Though FIG. 1 shows only one of each of these types of user entities, system 5 preferably accommodates many of each type of user.

It is preferred that the users of system 5 be electronically connected to system 10 through the Internet 15 or some other type of network. Such users may generally be classified as primary users in that they are primarily, or directly, involved with the treatment of employee/patient 30 throughout the worker's compensation claim process. Additional entities not shown in FIG. 1 may also be users of system 5, and may include insurance brokers, attorneys and consumers. Such users may be classified as secondary users since they may be only peripherally involved with the worker's compensation process. Other entities may also use system 5.

The medical management system and method 5 is preferably based on software 10 that provides an electronic medical record interface for the user. Web site 12 and software 10 may reside on server 7 and may be accessed via the Internet 15 or some other network. However, software 10 and/or web site 12 may reside on another server not maintained by administrator 6. As such, the current invention is not limited to the exact configuration shown in FIG. 1. To provide easy access by the various users of system 5, it is preferred that software 10 operate with any standard web browser, e.g., Microsoft's Internet Explorer or Netscape's Navigator, from any computer having access to the Internet or other pertinent network.

a. Virtual Medical Group/Fully Integrated Solution

With the electrical connectivity provided between system 5 and the various users, the current invention essentially provides for a “virtual medical group”. That is, system 5 may capture, store and retrieve a patient's medical records from any computer that has access to the Internet or some other network, together with the appropriate authorization and security. This information need not be limited to strictly medical information. Indeed, demographic and other information pertaining to patients 30 and other users may be stored in database 18 and provided to authorized users of system 5. In sum, system 5 may provide the capability to share up-to-date employee medical and other information with the various users.

As such, system 5 provides a comprehensive, fully integrated solution for the life cycle management of information associated with, for example, worker's compensation claims. System 5 provides for full integration because each entity that may participate in a worker's compensation claim may interact with system 5 and with each other regarding pertinent medical records. And as discussed below, various filters may be placed on medical records so that only appropriate information is provided to the various entities that may access a patient's medical records through system 5.

b. Acquiring Users

The manner in which the various users may come to be involved with system 5 is now more fully described. It is preferred that the coordinator's web site 12 includes details on becoming a user of system 5. To this end, web site 12 may provide a demonstration of system 5 tailored for each type of user. The web site 12 may also provide electronic forms for the prospective user to fill out and transmit to coordinator 6.

It is also contemplated that referrals from existing users may account for many new users. For example, existing physician users 26 may refer additional physicians. And where a physician cares for the employees of employer 28 that is covered by a particular insurance company 24, employer 28 and/or insurance company 24 may also encourage the physician to participate. Coordinator 6 may offer incentives (which may be posted on web site 12) to existing users to refer new users. Since employers 28 may control the flow of patients, it is preferred that coordinator 6 align itself with various employers 28.

c. Database Configuration

The configuration of system 5 is now further described. Software 10 may be associated with a central database 18. Though FIG. 1 illustratively shows central database 18 and software 10 separate from server 7, central database 18 and software 10 may reside on server 7 or on another server. Central database 18 preferably includes a patient record database 20 where patient medical records may be stored and accessed. Central database 18 also preferably includes a treatment protocol database 22 where treatment procedures corresponding to physician diagnoses may be located. Other databases depicted in FIG. 1 as reference numeral 23 may also be used to facilitate software 10 and system/method 5. For example, where the current invention is used in non-medical applications, database 23 may contain other non-medical information necessary or desired for system 5 to operate.

d. Other Services on Coordinator's Web Site

In FIG. 1, system 5 is depicted as only a portion of administrator 6. This is because administrator 6 may offer other services and features on web site 12 such as various e-commerce services. In the medical field, for example, coordinator 6 may provide business-to-business services whereby web site 12 provides a forum for employers 28 to obtain worker's compensation insurance from insurance companies 24. Alternatively, for self-insured employers 28, web site 12 may provide information regarding information and guidelines for such self-insurance. Also, personal injury lawyers may use web site 12 as a source of business relationships.

As examples of other services, coordinator 6 may provide data management and electronic medical record services to physicians, employers and insurance companies. Coordinator 6 may also provide e-mail or other communication services so that all users of system 5 may readily communicate with each other. In this manner, coordinator 6 may provide a virtual medical group of medical clinics networked together and all seamlessly linked by the Internet 15 (or a virtual private network) whereby electronic medical records may be created, stored and accessed by various entities. It should be noted that in FIG. 1, Internet 15 may be replaced with some or private or public network.

Coordinator 6 may also provide medical billing and collections of medical claims, maintenance of billing codes, marketing services, consulting services to assist employers reduce hazardous workplace conditions, etc. Coordinator 6 may also provide and install the necessary hardware and/or software at the user locations when a user elects to participate in system 5.

Coordinator 6 may also provide various services that derive from the fact that the coordinator's database 18 contains a wealth of information from the various users of system 5. Coordinator 6 may provide this information to its various users to help them address issues that they may face. To this end, it is preferred that information that is confidential to one user be treated as such when making it available to other users.

e. Security

In FIG. 1, an insurance company 24, a physician 26, an employer 28 and an employee 30 of the employer 28 are shown as users of system 5. To maintain the secrecy of confidential medical records, these entities may first need to obtain authorization from coordinator 6 to access system 5. Other entities may also become authorized to use system 5, e.g., insurance brokers and medical clinic personnel.

Predetermined access rules may be used to establish which entities are authorized to use system 5. All entities that register for and are approved to use system 5 generally become authorized users, and each authorized user is preferably provided with its own password for accessing system 5. In a preferred embodiment, authorized users may visit the coordinator's web site 12 and enter its password to access system 5.

Referring to FIG. 1, each of the authorized users 24, 26, 28, 30 preferably has at least one computer terminal connected to system 5 via the Internet 15 by electronic links 32a, 32b, 32c, 32d respectively. Alternatively, the users may be connected to system 5 by another type of network. The electronic links 32a, 32b, 32c, 32d preferably allow authorized users 24, 26, 28, 30 to access the pertinent patient record database 20 where they may access, store, retrieve and/or disseminate patient medical records of employee 30.

Each authorized user's password may provide access to only appropriate information in system 5. To this end, a particular authorized user may be provided with only certain patient records. For example, a particular employer's password may provide access only to the patient records of its employees 30. Similarly, a particular insurance company 24 may have a password providing access only to the medical records of patients employed by the employers it insures. In this manner, system 5 may “filter” the access provided to its users thereby maintaining patient confidentiality.

The security provided by system 5 is preferably HIPPA compliant. Security measures such as biometrics authentication may be used. Furthermore, 128 bit encryption may be used for identifier fields of information. As discussed later, the electronic medical records and other information stored in database 18 is preferably contained in a relational database. It is preferred that system 5 provide controlled access down to the individual field level of tables in the relational database. In this manner, a user may obtain access to certain types of records and reports, but may not be able to access certain underlying information contained in the individual fields of that record or report that may be confidential.

f. Methodology of Information Management System

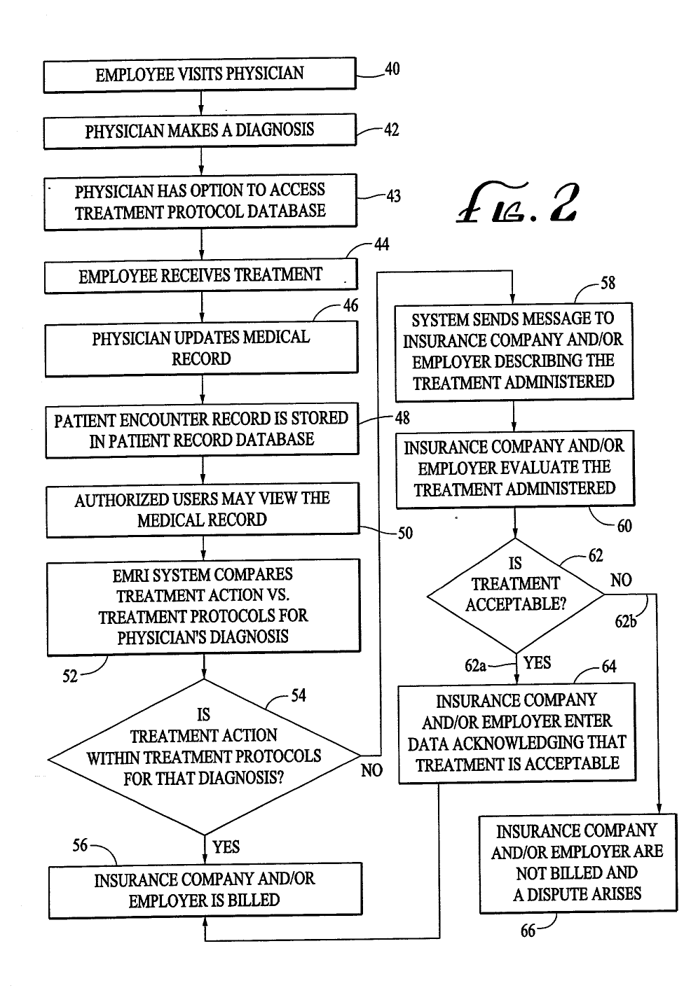

The manner in which system (and the associated method) 5 may be implemented in the worker's compensation or occupational healthcare field is now further described with reference to FIG. 2. The following discussion assumes that a plurality of insurance companies 24, physicians 26, employers 28 and employees or patients 30 are associated with, and are thus authorized users of, system 5.

An employee/patient 30 may visit physician 26 at the physician's office as shown in step 40. In the worker's compensation example, employee 30 would typically be visiting physician 26 due to a work-related injury. After examining employee 30, physician 26 preferably makes a diagnosis as shown in step 42.

In a preferred embodiment, the physician's diagnosis is required before system 5 will bill insurance company 24 and/or employer 28 for the employee's visit. This reflects the cost containment and fraud avoidance aspects of the current invention. That is, by requiring a diagnosis to be made physicians and employees may be less likely to fabricate a patient visit because specific, identifiable information regarding a diagnosis will need to be provided before a billing is made.

Referring again to FIG. 2, physician 26 may then access the treatment protocol database 22 for aid in determining which treatment procedures are appropriate for the given diagnosis, as shown in step 43. It is preferred that physician 26 may readily access these protocols through his or her computer, e.g., during the patient's visit. For example, physician 26 may log onto the coordinator's web site 12 and obtain information from protocol database 22 to obtain the appropriate treatment.

Physician 26 may be required to provide his or her password to gain access to protocol database 22. For example, in obtaining a treatment protocol, physician 26 may need to access the patient's confidential medical information, and as such, may need to provide a password.

The treatment procedures located in treatment protocol database 22 are preferably pre-approved by insurance company 24 and/or employer 28 before they are programmed into software 10 and stored in treatment protocol database 22. Such pre-approval allows insurance company 24 and/or employer 28 to monitor what types of treatments will be provided and the likely costs to be incurred. Such pre-approval may also increase the likelihood that physician 26 will administer appropriate care to the employee 30 according to the protocols since physician 26 will be aware of what treatment procedures are considered acceptable to the payors, i.e., insurance company 24 and/or employer 28. To this end, it is preferred that only a finite number of treatments are suggested for a given diagnosis.

The protocols stored in database 22 may vary between employers 28 and/or insurance companies 24. For example, different employers 28 may believe that certain diagnoses should receive different treatments for one or more reasons. For example, different employers may receive different expert medical advice regarding the proper treatment for certain diagnoses. As another example, different employers 28 and/or insurance companies 24 may have cost structures dictating that certain treatment protocols be followed. Accordingly, when accessing database 22, physician 26 preferably inputs information identifying the employer 28 (and/or insurance company 24) of the patient 30 he or she is treating so that the pertinent list of protocols is obtained.

Thereafter, employee 30 may receive treatment from physician 26 as shown in step 44. For the majority of treatments provided to patients 30, it is contemplated that a pre-approved protocol from database 22 will be used for treatment. However, the treatment administered by physician 26 may or may not fall within the treatment protocols specified for the given diagnosis. In other words, physician 26 still preferably retains discretion in deciding which treatments are administered to patients 30.

During and/or after a patient visit or other event involving patient 30, physician 26, or a member of the physician's staff, preferably updates the medical records in system 5 that pertain to employee 30 as shown in step 46. It is preferred that existing electronic medical records for that patient not be deleted from the pertinent database of system 5. Instead, it is preferred that a new version of an existing record is created to reflect the updated information. This way, the patient's medical history throughout the worker's compensation claim process may be readily tracked.

As mentioned above, it is preferred that passwords be required to access system 5 in order to update a patient's medical records. This maintains confidentiality of patient information and also maintains the integrity of the information contained in the medical records by avoiding individuals unrelated to a given patient from updating that patient's medical records. Generally, it is preferred that medical records be updated frequently so as to maintain the real-time information feature of system 5.

Medical records are preferably updated by entering data pertaining to the patient's visit at a computer terminal electronically linked to web site 12 via the Internet 15 through link 32b. System 5 may store the employee's 30 medical information in the patient record database 20, as shown in step 48. Thereafter, it is preferred that the employee's updated medical record may be viewed by any of the authorized users 24, 26, 28, 30 from any computer terminal having Internet access as shown in step 50.

It is also preferred that system 5 stores all, most or some number of the medical records associated with a patient's treatment as the patient proceeds through his or her treatment. To this end, it is preferred that a particular medical record not be deleted or changed. Instead, it is preferred that new medical records be created that may be new “versions” of existing records from the beginning to the end of the patient's treatment. As such, authorized users may readily review the treatment history of a particular patient/employee 30 and the patient/employee's recovery. This may be useful in avoiding or addressing fraudulent worker's compensation claims.

It is also preferred that all the medical records associated with a particular patient/employee 30 have some type common identifying code. This allows software 10 to refer to all records associated with a particular patient 30 through a relational database as discussed later. This in turn allows various types of reports to be provided regarding that patient.

After the patient encounter data has been stored, system 5 preferably compares the treatment action taken (or to be taken) by physician 26 to the treatment procedure stored in treatment protocol database 22 that corresponds to the diagnosis given by physician 26. This comparison is shown as step 52 in FIG. 2. If the treatment action falls within the treatment protocol specified for that diagnosis, system 5 preferably sends an electronic bill to the insurance company 24 along electronic link 32a and/or to the employer 28 along electronic link 32c, as shown in steps 54 and 56.

This electronically automated billing system reflects an advance of the current invention for at least several reasons. First where there is no deviation from the protocols maintained by system 5, the automatic generation of a bill avoids an employee of the physician 26 or other entity from having to spend time doing so. Second, it is contemplated that such automated billing would less likely lead to billing errors since the chance of human error is reduced or eliminated.

If the treatment action taken (or to be taken) by physician 26 does not fall within the treatment protocols specified for the diagnosis, coordinator 6 and system 5 preferably sends a message to insurance company 24 and/or employer 28 describing the deviation. This is shown in FIG. 2 as step 58. This message is preferably sent electronically through links 32a, 32c. A copy of the message may also be sent to the prescribing physician to apprise him or her that a deviation has been reported to insurance company 24 or employer 28. Alternatively, a copy of the message need not be sent to the prescribing physician.

The deviation message sent to insurance company 24 and/or employer 30 may describe the treatment actually performed (or prescribed) by physician 26 as well as the treatment set forth in the appropriate protocol. This way, insurance company 24 and/or employer 30 may be able to readily ascertain the extent to which the protocol was not followed. Insurance company 24 and/or employer 28 may then evaluate the treatment administered to determine whether it was appropriate for the physician's diagnosis, as shown in step 60.

It may be that deviations are frequently reported for a particular protocol stored in treatment protocol database 22. This may be a sign that the protocol stored in database 22 should be changed to reflect a treatment that is typically being provided by physicians 26. It is preferred that coordinator updates and maintains the protocols stored in database 22 as needed or otherwise desired. In this manner, system 5 and coordinator 6 may help maintain and/or increase the level of health care quality being provided to patients 30.

Alternatively, if the deviation messages sent are repeatedly about a particular physician 26 or physicians 26, this may be a sign that this physician(s) is not providing proper treatments and should thus be contacted and/or eliminated from system 5. This is another manner in which system 10 provides quality control in health care.

Referring again to the evaluation in step 60, the treatment action taken by physician 26 described in the deviation message may be found acceptable as shown in step 62a. In this case, insurance company 24 and/or employer 28 may advise system 5 acknowledging as much, as shown in steps 62 and 64. System 5 may then send an electronic bill to insurance company 24 along electronic link 32a and/or to employer 28 along electronic link 32c, as shown in step 56.

If the physician's treatment is found not to be acceptable as shown in step 62b, insurance company 24 and/or employer 28 are preferably not billed for that particular patient visit. It is also preferred that insurance company 24 and/or employer 28 are provided a means to dispute having to pay for such an employee visit, as shown in step 66. When such a dispute arises, insurance company 24 and/or employer 28 may settle their dispute with physician 26 by telephone, correspondence, or any other suitable means. To this end, coordinator 6 may provide a dispute resolution forum as part of its web site 12. Each dispute handled over the coordinator's web site 12 may be secured so that the dispute is not accessible to other users of system 10.

Thus, as described above, only treatments that fall outside of the specified treatment protocols require monitoring by insurance company 24 and/or employer 28. As such, insurance company 24 and/or employer 28 preferably need to spend less time monitoring the medical treatment of their employees 30 thereby reducing the costs generally associated with medical treatment of employees, and more particularly, reducing costs associated with worker's compensation claims.

This reflects a significant advance over existing systems in which the insurance company and/or employer monitors each treatment. That is, the current invention provides for a significant reduction in the time and cost necessary for monitoring the treatment of patients 30.

The process described above can be followed for multiple patients, e.g., multiple employees of a single employer 28 or multiple employees of different employers authorized to use system 10. Moreover, the steps shown in FIG. 2 may be altered or arranged in a different sequence. For example, system 5 might send an electronic bill to insurance company 24 and/or employer 28 immediately after physician 26 updates the employee's medical record in system 5, regardless of whether the treatment administered falls within the specified protocols. In this alternative, system 5 may then send an electronic message to insurance company 24 and/or employer 28 describing the treatment action performed by physician 26 for the given diagnosis.

g. Reports

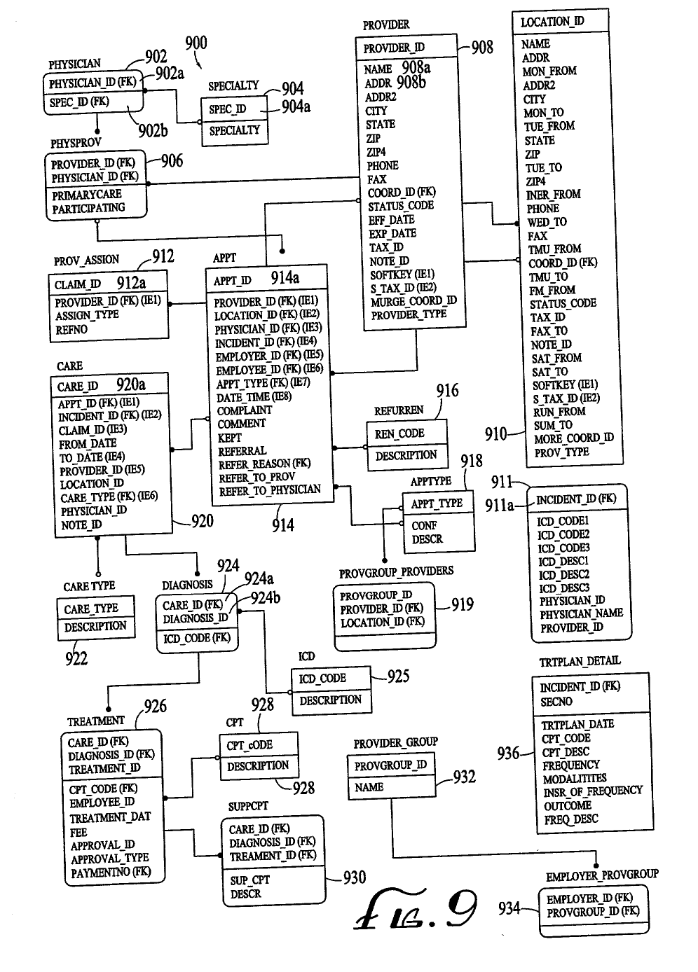

The various types of reports that may be provided by system 5 are now more fully described. As mentioned above, various types of information may be provided in the reports sent to the users of system 5. To this end, the reports are generally based on information contained in a relational database as discussed later in connection with FIG. 9. As such, information in relational database may be manipulated according to various formatting parameters to provide various reports to the user's computer screen which may then be printed out.

Once a report appears on a user's computer screen, it is preferred that the underlying detail of a particular number or other information contained in the report may be obtained by simply “drilling down”, i.e., clicking on that number or information appearing on the computer screen. In this manner, a subsequent report may the appear on the user's computer screen revealing all the information underlying the number in the first report. If desired, the user may continue to drill down to the point of viewing basic information such as work status and a physician's notes for a specific employee/patient 30. In this manner, the employer 28, insurance company 24 and other interested entities having authorization for this information may readily obtain any level of detail about a worker's compensation claim.

A unique advantage of the current invention is that this wealth of information may be obtained without having to call the physician or clinic 26 or sending letters or faxes requesting this information. As such, the current invention provides a significant time savings. It is preferred that the information input into the relational database and the electronic medical records contained in system 5 are updated frequently so as to provide real-time information.

The types of reports that may be provided may be governed by the type of entity seeking the report, the user's password or other parameters. For example, certain types of reports may be available to only insurance companies while other types of reports may be available to only employers. However, a given report may be available to more than one type of entity. As another example, a certain employer may be able to obtain reports regarding only its employees while an insurance company may be able to obtain only those reports about employers (and its employee/patients) that it insures.

Certain types of reports may be automatically generated while other may need a user request to obtain. For example, once a patient 30 visits a physician 26, a schedule of follow-up appointments, e.g., physical rehabilitation for the employee's injury, may be established and a report outlining this schedule may be automatically provided to the employer 28. With such a report, employer 28 may plan its manpower needs because it will generally have an idea of when the injured employee 30 will be able to return to work. As another example, if any of the follow-up appointments are missed by employee 30, a report of this may be automatically sent to employer 28. This puts employer 28 in the position of following up with its employee 28 detecting fraud and also provides employer 28 with an updated estimate of when the employee 28 may return to work. It should be noted that such reports may be obtained upon request in addition to, or instead of being, automatic.

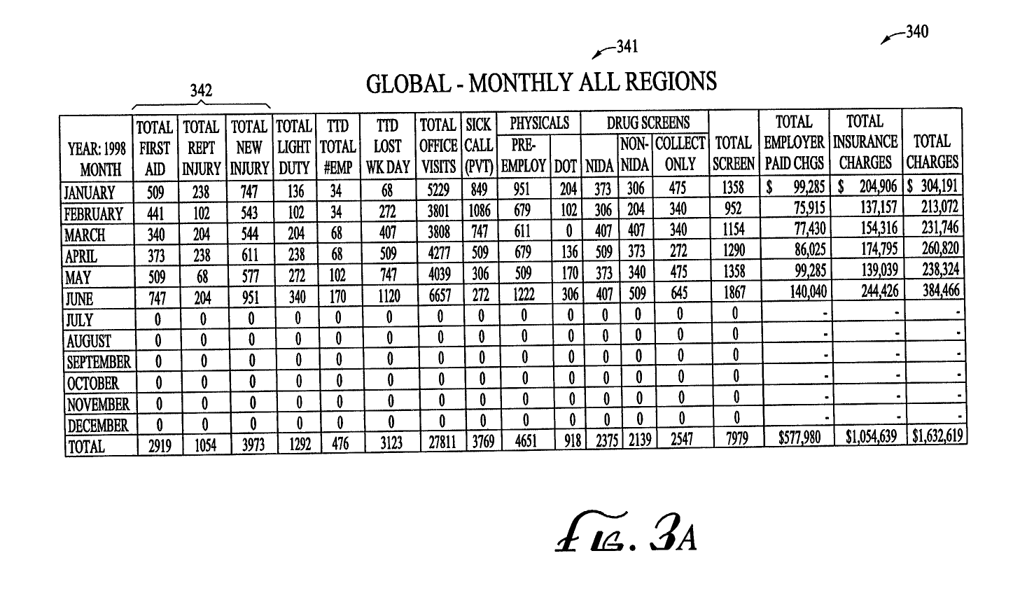

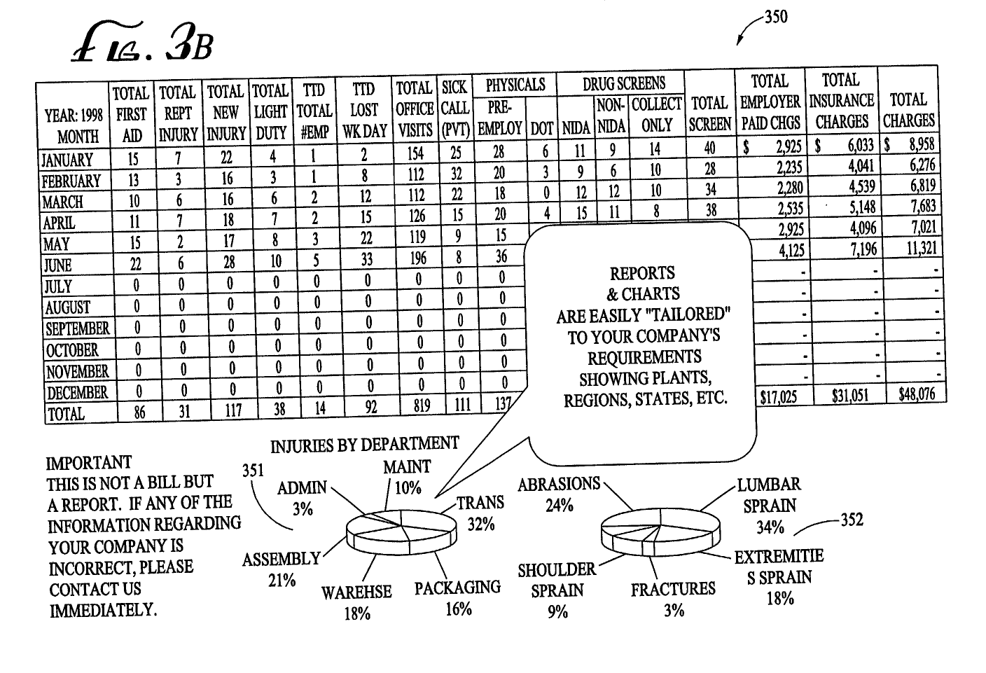

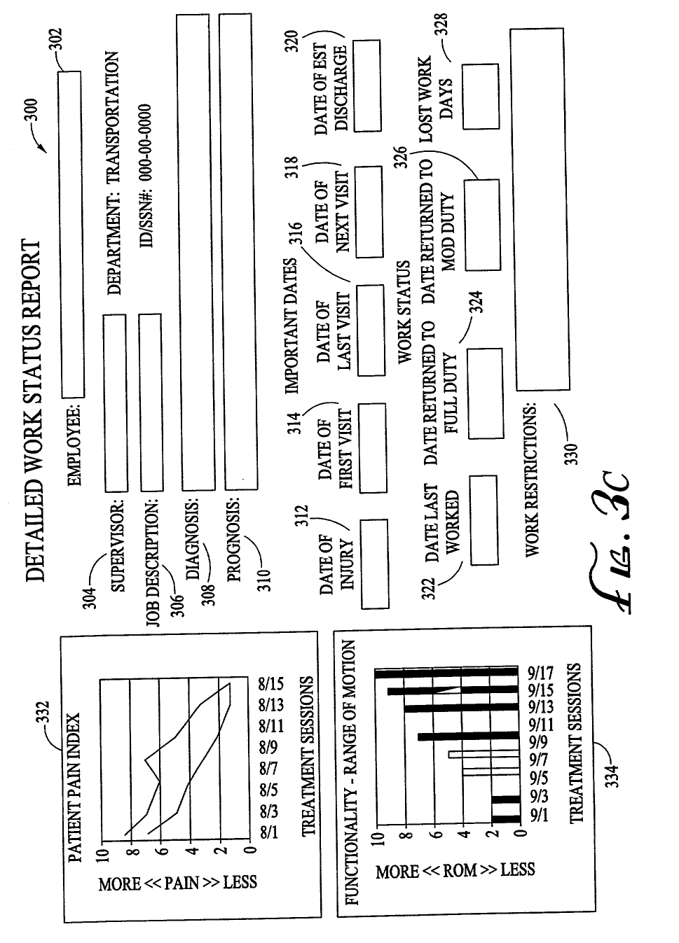

Referring now to FIGS. 3a-3c, other sample reports as they may appear on a user's screen are now discussed. FIG. 3c shows a detailed work status report 300. As shown, report 300 may include fields for employee identification 302, supervisor identification 304, job description 306, diagnosis 308 and prognosis 310. Report 300 may also set forth important dates associated with the worker's compensation claim such as the date of the injury 312, date of first visit 314, date of last visit 316, date of next visit 318 and date of estimated discharge 320.

Report 300 may also set forth work related information such as the date last worked 322, the date the employee returned to full duty 324, the date the employee returned to modified duty 326 and the number of lost work days 328. Information on the work restrictions 330 may also be included. Useful graphs may be included in report 300. For example, graph 332 charts patient pain index vs. the date of the treatment sessions, and graph 334 charts range of motion vs. the date of the treatment sessions. As mentioned above, it is preferred that various numbers in the report 300 may be clicked on by the user so as to drill down to the underlying data.

FIG. 3a shows a global summary report 340 for certain of an employer's charges and other healthcare-related information. The information is shown on a monthly basis. As shown, report 340 has various identification fields 341 to identify the employer and contact information as well as the employer's type of business. The report 340 also contains various injury fields 342 for quantifying information such as the number of injuries sustained by employees, the number of employees injured, the number of lost work days, the number of office visits, etc. Report 340 may also include various information about the employer's costs related to such injuries. Besides providing valuable information to employer 28, report 340 may be of interest to insurer 24. This is because insurer 24 will be able to gauge its risk in insuring employer 28 by viewing the number of injuries it will have to pay to be treated.

As mentioned above, it is preferred that the user may click on certain of these numbers to drill down to the supporting information. This drilling down may preferably continue until basic information is displayed, e.g., specific employees, specific types of injuries, etc. For example, various numbers appearing in the report of FIG. 3a may be clicked on by the user to eventually arrive at the detailed work status report of FIG. 3c for a particular employee/patient 30. To this end, there may be several reports between the reports of FIGS. 3a and 3c when drilling down, but successive clicks on certain numbers preferably provides the user with the desired level of detail. In similar fashion, the user may return to higher level, global reports.

FIG. 3b shows an injury summary report 350 that is similar to the report of FIG. 3a, but is for one of the employer's specific locations. As shown, report 350 may include easy to understand graphics such as chart 351 that shows the percentage of total injuries attributable to each department and chart 352 that shows the percentage of total injuries attributable to each type of injury. As with other reports, it is preferred that the user may click on various data in the report to drill down and view underlying information.

It should again be noted that FIGS. 3a-c represent only a fraction of the types of reports that may be generated by system 5. Other reports may also be generated such as reports on government employee safety requirements, e.g., OSHA reports, state, county or city guidelines and educational and safety logs. Other reports on insurance services or other information may also be generated.

h. Overall Data Flow

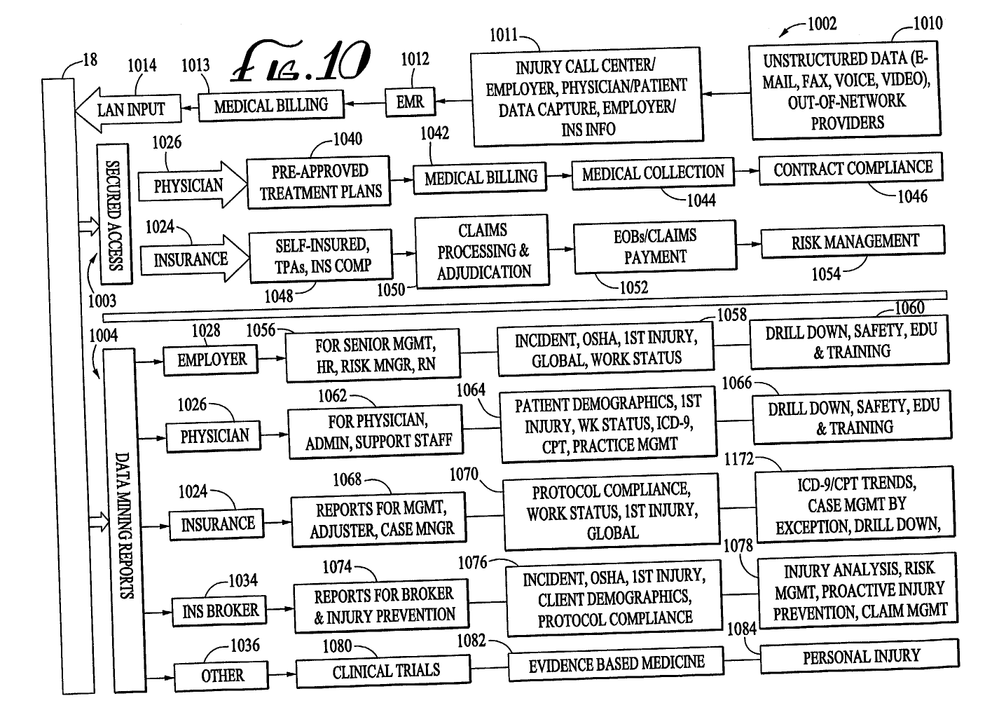

Referring now to FIG. 10, the interaction between coordinator 6 and the various users of system 5 is now discussed in more detail with regard to the worker's compensation application. As shown, central database 18 may communicate with the various user insurance companies 1024, physicians 1026 and employers 1028, as well as insurance brokers 1034 or other type of entities 1036.

As shown in FIG. 10, database 18 may generally communicate with authorized users in connection with receiving information and capturing data 1002, providing secured access 1003 to authorized users in connection with the treatment of patients and processing of worker's compensation claims and providing reports 1004.

The process of receiving information and capturing data 1002 may generally start with the collection of unstructured information data assets 1011. As shown, unstructured data assets may include e-mail, fax, voice, video, documents, forms, electronic files, e.g., Word, Excel documents, and other sources of information. To this end, unstructured data assets may be received from providers that are not authorized users of system 5.

The collection of unstructured data assets may occur in a data capture step 1011 during which the unstructured assets 1010 may be electronically input into a form usable by system 5. Data capture 1011 may include information obtained from an injury call center, employer 1028, physician 1026, patient 1030, insurer 1024 or other source. The data capture step 1011 may occur by the user's inputting data. Electronic forms appearing on the user's computer screen may be provided by system 5 to aid in this data entry. It is preferred that the forms are easy to understand to facilitate the accurate input of data. Alternatively, coordinator 6 may provide a data entry service. In any event, the result of the data capture step 1011 is preferably an electronic medical record 1012 that may be stored in database 18 and used by system 5.

Along with the electronic medial record 1012, medical billing information 1013 may also be collected by a local area network 1014 or other computer or device (collectively “electronic device”) and transmitted to database 18. The connection between electronic device 1014 and database 18 may occur through the Internet as shown in FIG. 1.

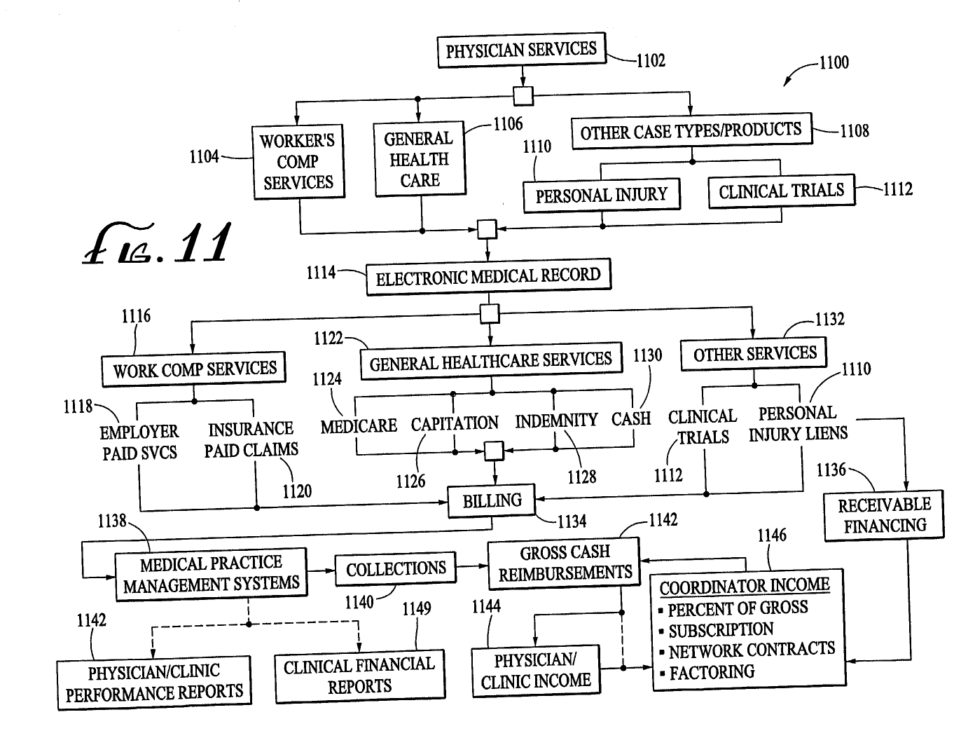

Database 18 may provide secured access 1003 to various users including physician 1026 and insurer 1024 as shown in FIG. 11. With respect to physician 1026, he or she may gain access to pre-approved treatment plans (such as the treatment protocols discussed above) 1040. Physician 1026 may also obtain medical billing services 1042, medical collection services 1044 and contract compliance services 1046.

With respect to insurer 1024, database 18 may provide information on self-insured companies 1048 that may be suitable for purchasing worker's compensation insurance. Insurer 1024 may also obtain access to information from database 18 on other companies with which it may do business. Secured access 1003 may be used by insurer 1024 for claims processing and adjudication 1050, EOBs and claims payment 1052 and risk management information 1054.

Database 18 also preferably provides many different types of reports 1004 to the various users. Employer 1028 may obtain various types of reports 1056 for senior management, human resources, risk managers and registered nurses. Database 18 may also provide other reports 1058 such as injury reports, OSHA reports, first injury reports, global summary type reports and work status reports. These other reports 1058 may be generated directly from database 18 or may result from drilling down the relational database based on numbers in a report 1056. It is preferred that employer 1028 may drill down 1060 through reports 1056 and/or 1058 so as to obtain underlying reports and/or information such as safety, education and training.

Database 18 may generate reports 1062 tailored to the interests of the physician 1026, or his or her administrative or support staff. Other reports 1064 may also be generated for physician 1026 such as patient demographics, first injury, work status, ICD-9, CPT and practice management reports. These other reports 1064 may be generated directly from database 18 or may result from drilling down the relational database based on numbers in a report 1062. It is also preferred that physician 1026 may drill down 1066 through reports 1062 and/or 1064 so as to obtain underlying reports and/or information such as safety, education and training.

Database 18 may generate reports 1068 for management, insurance claims adjustors and case managers. Other reports 1070 may also be generated such as protocol compliance, work status, first injury and global type summary reports. These other reports 1070 may be generated directly from database 18 or may result from drilling down the relational database based on numbers in a report 1068. The protocol compliance report may generally provide information on the number of times a given physician deviates from the treatment protocol when treating patients. Such a report may provide insight on whether the physician is providing proper care as well as whether the physician's care is cost efficient. It is preferred that insurer 1024 may drill down 1072 through reports 1068 and/or 1070 to obtain underlying reports and/or information such as ICD-I, CPT trends and case management by exception.

Database 18 may generate reports for insurance brokers 1034 that are authorized users of system 5, such as broker and injury prevention 1074 reports. Other reports 1076 may be generated for insurance broker 1034 such as incident reports, OSHA reports, first injury reports, client demographics and protocol compliance. These other reports 1076 may be generated directly from database 18 or may result from drilling down the relational database based on numbers in a report 1074. In any event, it is preferred that insurance broker 1034 may drill down 1078 through reports 1074 and/or 1076 to obtain underlying reports and/or information including injury analysis, risk management, proactive injury prevention and claim management.

Database 18 may also generate reports for other users 1036 such as clinical trial reports 1080, evidence based medicine reports and personal injury reports 1084. These other users 1036 may comprise attorneys or other individuals or entities involved in the healthcare field. It should be noted that database 18 may generate the same reports for different entities.

i. User Benefits

The ability to access patient record database 20, and the use of system 5 in general, affords many advantages to each of the authorized users 24, 26, 28, 30. For example, the integrated nature of system 5 allows all users to more easily communicate with each other throughout the worker's compensation claim process.

Insurance company 24 benefits because it is better able to contain costs due to physician compliance with treatment protocols. That is, insurance company 24 is given the opportunity to pre-approve the treatment protocols before they are entered into system 5. Thus, by using system 5, insurance company 24 need only monitor treatment actions that fall outside the specified protocols for given diagnoses. Accordingly, costs associated with review committees are reduced.

Another benefit to insurance company 24 is that it may better prevent fraudulent injury claims because it will have real time online access to patient files. Insurance company 34 will thus be able to monitor patient claims quickly and easily.

Another benefit to insurance company 24 is provided by the reports that may be made available by system 5. For example, insurance company 24 may obtain reports on a particular patient, on all or some patients employed by a particular employer, on multiple employer' employee/patients in a particular region or on other reporting bases. This may allow insurance company 24 to spot trends, problems or issues in healthcare management. This may also provide information to insurer 24 to justify changes in insurance premiums.

Additionally, because system 5 preferably includes all the parties relevant to the billing process, billing becomes more accurate and timely. In particular, whenever a physician 26 administers a treatment that falls within the protocols specified for a given diagnosis, system 5 may automatically bill insurance company 24, and no monitoring is required. Thus, efficiency in the billing process is increased.

Physicians 26 also receive various benefits from using system 5. First, system 5 automatically produces electronic charts when patient information is entered into the system, thus saving the physician 26 time usually spent creating handwritten charts. Besides the general modernization of the physician's record-keeping practices, physician 26 has more time to treat patients which preferably provides higher quality of care and the opportunity for increasing the number of patients that may be examined.

Also, system 5 increases quality assurance by providing physician 26 access to the treatment protocol database 22. Such access allows physician 26 to review which treatment procedures correspond to specific diagnoses and which procedures have been pre-approved by an insurance company 24 and/or an employer 28.

Also, treatment protocol database 22 preferably contains detailed medical information relating to various diagnoses and corresponding treatment procedures, which preferably lends support to physician 26 when physician 26 treats a patient 30. Accordingly, the risk of malpractice is reduced because physician 26 is provided with vital treatment information each time a diagnosis is made, thus lessening the likelihood that the physician 26 will make improper treatment decisions.

Physician 26 also preferably realizes cost savings as a result of the system's 5 automatic billing process. Whenever a treatment is administered that falls within the specified protocols for a given diagnosis, or whenever insurance company 24 and/or employer 28 approve a treatment that falls outside the protocols, system 5 preferably sends an electronic bill to insurance company 24 and/or employer 28. Accordingly, fewer staff members are required to maintain the billing process, and physician 26 may greatly reduce the size of his or her billing department. Moreover, physician 26 preferably receives payment more rapidly due to the speed imparted by the automatic billing process of system 5.

As a further benefit, by participating in system 5, physician 26 may experience a growth in practice size due to referrals and ease of accessibility through the Internet 15. Indeed, the other e-commerce services that may be provided by coordinator 6 may increase or otherwise enhance the physician's practice.

System 5 also provides benefits to employer 28. First, employer 28 may verify the medical and/or work status of its employees online in real time. This may occur through the various reports that system 5 may provide. For example, employer 28 may inquire into the status of a particular employee 28. Alternatively, employer 28 may obtain a global type report which may provide an overall summary of all or some portion of the pending worker's compensation claims involving that employer 28.

As such, employer 28 may generally be kept aware of available manpower. Such verification is particularly valuable for employers that have employees traveling throughout the country and who are therefore not always located in one place. Furthermore, all employee medical information is preferably consolidated in the patient record database 20, so that employer 28 may access patient records for multiple employees from one computer terminal.

The employer's 28 potential liability is also reduced as a result of the increased quality of patient care that preferably results from physician compliance with treatment protocols. Specifically, it is contemplated that employees are likely to receive better quality treatment when physicians have protocols as guides. Accordingly, it is contemplated that potential liability for improper medical care is reduced or avoided.

Additionally, employer 28 will be able to more easily discover and prevent fraudulent injury claims because employer 28 may check system 5 to verify that its employees have actually visited a physician 26 and have been treated for specific injuries or ailments. With such real time capability, employer 28 may readily know whether an employee is in condition to work but is choosing not to under false pretenses.

Another benefit to employer 28 is a reduction in costs associated with employee healthcare. This may result from a reduction in fraudulent claims. And because system 5 preferably provides higher quality healthcare by providing treatment protocols, the number of patient visits may be reduced. Furthermore, the overall efficiency provided by system 5 preferably reduces the number of lost work days.

It should be noted that the foregoing employer benefits also preferably apply to self-insured employers 28. To this end, it will also receive the same benefits that insurance company 24 receives, as described above, including more timely and accurate billing.

Employee 30 also preferably benefits from system 5. First, the quality of medical care that employee 30 receives is preferably improved because physician 26 has access to treatment protocols that correspond to the physician's 26 diagnosis of the employee's 30 condition. Thus, physician 26 has vital medical information readily available whenever treating an employee 30 for an injury or ailment.

Furthermore, employee 30 may preferably visit any clinic that utilizes system 5, as opposed to being forced to visit only clinics near the employee's 30 place of business. This is so because care providers at every clinic using system 5 preferably have access to the employee's 30 medical records. As such, the employee/patient's medical records follow the patient to whichever clinic he or she may visit.

The feature providing employees a variety of clinics at which to receive treatment may be particularly valuable where the employee/patient does not speak a certain language. For example, many workers in the United States do not speak English as their primary language, and often live in areas where the majority of people speak the same language that they speak. Accordingly, the current invention contemplates that such workers may visit clinics near their homes where the physicians and medical staff speak their primary languages fluently.

j. Business and Revenue Models

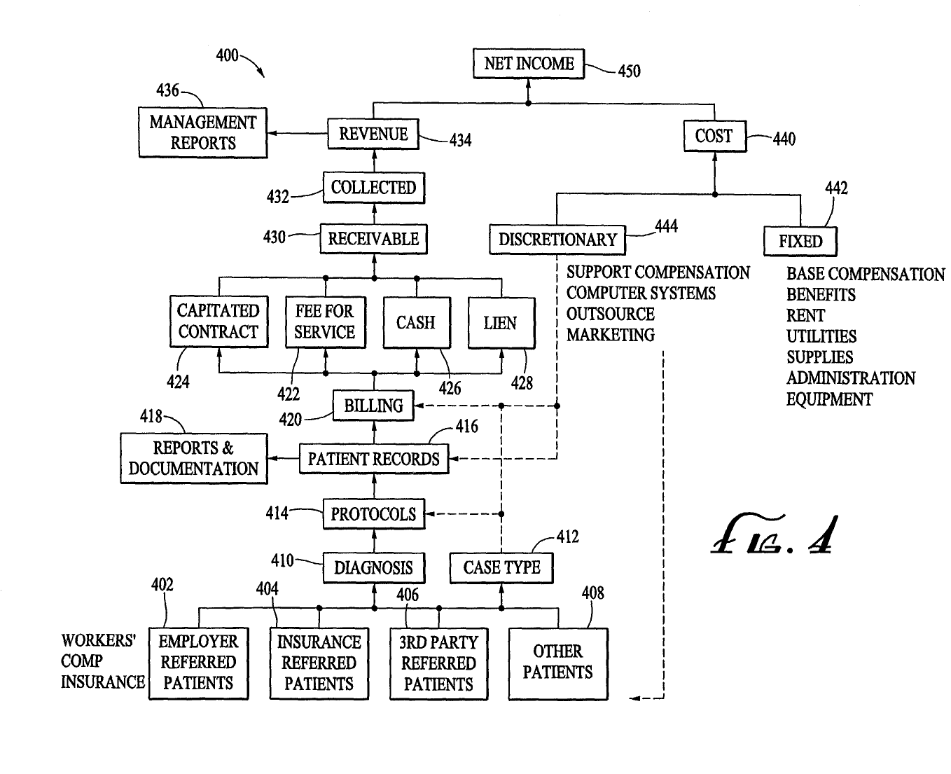

Referring now to FIGS. 4, 5 and 11, business models and methods of generating revenue in connection with system 5 are now described. These methods also further show how different users may interact with system 5. The revenue generation method 400 of FIG. 4 describes a revenue generation method for physicians 26 and clinics that participate in system 5. It is contemplated that this method of generating revenue will provide an incentive for physicians to become users of system 5. Method 400 generally includes a revenue side which appears on the left of FIG. 4 and a cost side which appears on the right.

As shown, patients 30 may be referred to physician 26 in different ways. In worker's compensation claims, employer referrals 402 may generally constitute a significant percentage of a physician's referrals. Because it is contemplated that many worker's compensation patients will be referred by their employers 402, FIG. 4 shows a heavy line in connection with this part of the flowchart. However, patients may also visit physician 26 by virtue of insurance company referrals 404, third party referrals 406 or otherwise 408.

Regardless of how patients 30 are referred, physician 26 then generally determines a diagnosis 410, or alternatively, patient 30 is categorized according to case type 412. Thereafter, physician 26 may then consult with system 5 for the appropriate treatment protocols 414. Patient records 416 may then be created, revised or otherwise maintained to reflect the diagnosis and/or treatment prescribed. These patient records are preferably electronic and in a form so that they may be stored in database 20 for later updating or access by users of system 5.

Based on these patient records 416, various reports and/or documentation 418 such as the types discussed above may be generated. It is preferred that records 416 include identification codes and/or other indicia that permit reports 418 to be generated by a relational database in system 5 in various formats for use by different users of system 5. It is also preferred that such records 416 be created and/or updated frequently to maintain the real-time aspect of the current invention.

Thereafter, physician 26 may initiate a billing cycle 420 which may generally reflect his or her fees for the services provided 422. Alternatively, the physician's billing cycle 420 may involve a capitated contract 424, cash 426 or a lien 428 on some asset belonging to the patient 30. As fees for service 422 is the typical billing cycle, it is shown in a heavier line in FIG. 4. Whatever type of billing 420 is used, an account receivable 430 is then generated.

The account receivable is then generally collected as shown in step 432. As part of its services, coordinator 6 may provide bill collection services or guidance thereon. Collections 432 then generally result in revenue 434, and management reports 436 may be generated from this information. Such reports 436 may be of the type discussed above.

Referring to the right side of FIG. 4, costs 440 may generally comprise fixed costs 442 and discretionary costs 444. As shown, fixed costs 442 may include base compensation, benefits, rent, utilities, supplies, administration and equipment. Discretionary costs 444 may include support compensation, computer systems, outsourcing of services and marketing. As shown in FIG. 4, some part of discretionary costs 444 may be passed through to patients 30 through the physician's billing 420. Furthermore, some of these discretionary costs 444 may be reflected in patient records 416 and reports 418. In any event, revenue 434 less costs 440 will generally provide a net income 450 for physician 26.

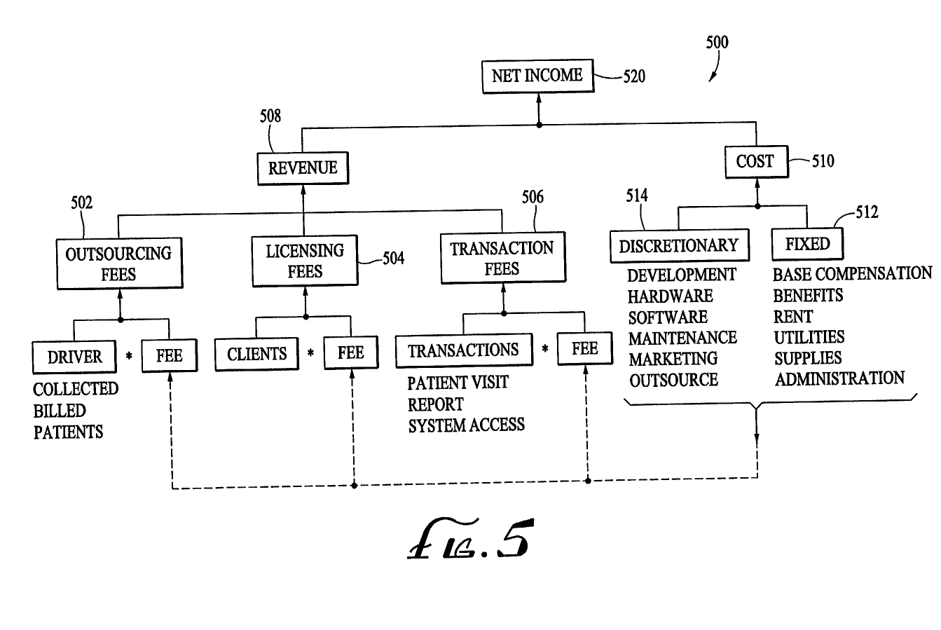

Referring now to FIG. 5, another method 500 of generating income for coordinator 6 is shown. As shown, revenue may be generated from participating physicians 26 by outsourcing service fees 502, licensing fees 504 and/or transaction fees 506. The fees generated from outsourcing 502, licensing 504 and transactions 506 generally combine to create overall revenue 508.

To generate outsourcing fees 502, coordinator 6 may perform services such as billing and collection services for physicians 26. These fees may be based on a certain percentage of the physician's gross cash from billings. As shown in FIG. 1, coordinator 6 may in turn engage a billing and collections (or other type of outsourcing company) to perform these services, with a profit built in for coordinator 6.

The billing and collection company may be electronically connected to coordinator 6 and system 5 via the Internet 15 though connection 32e. In this manner, the billing information for physician or clinic 26 may be readily transmitted to outsourcing company 40 for collection purposes. Outsourcing company 40 may also provide other services, e.g., provide supplemental information required by insurance company 24 before payment is made, re-bill for uncollected funds, provide performance and status reports of billings and collections, etc.

To generate licensing fees 504, coordinator 6 may charge physicians 26 a licensing, subscription, access or other type of fee to participate in system 5. The motivation for physician's to pay this fee 504 may be any of the benefits described above. The amount of licensing fee may vary according to the size of clinic 26 or the volume of patients seen by the physician or clinic 26. Other factors may influence the amount of the licensing fee.

Coordinator 6 may also charge licensing or other types of flat subscription fees to other entities using system 5. For example, insurance companies 24 and insurance brokers may be charged subscription fees. The motivation for insurance companies 24 to pay such fees would be the benefits described above.

To generate transaction fees 506, coordinator 6 may charge participating physicians 26 a fee for each transaction that physician conducts over system 5. This type of revenue generation model may be particularly appropriate where the participating physician 26 does not conduct a large amount of worker's compensation business thereby making a flat subscription fee impractical. Different amounts may be charged for the different types of transactions that may occur over system 5. For example, physician or clinic 26 may pay one fee for access to protocols in database 22 and another fee for obtaining reports.

As also shown in FIG. 5, coordinator 6 also incurs costs 510 that may include fixed costs 512 and discretionary costs 514. Fixed costs 512 may include base compensation, benefits, rent, utilities, supplies and administration. Discretionary costs may include development, hardware, software, maintenance, marketing and outsourcing of services. When costs 510 are deducted from overall revenue 508, coordinator 6 generates net income 520. As shown in FIG. 5, various costs or portions thereof may determine the fees to be charged.

Referring now to FIG. 11, another method 1100 of generating revenue regarding physician 26 and coordinator 6 is shown. Physician 26 generally provides services 1002 that may be worker's compensation services 1104, general health care 1106 and other case types and products 1108. The other case types 1108 may include personal injury 1110 and clinical trials 1112.

Regardless of the type of physician services 1102 provided, an electronic medical record 1114 is preferably created in a format so that it may be stored in the coordinator's database 18 (FIG. 1) and thereafter access, maintained or updated. These electronic medial records 1114 may also be used to generate reports as discussed above.

Thereafter, the electronic medical records 1114 may be used in connection with the payment of the physician services 1102. For example, the electronic medical records 1114 may be used in worker's compensation services 1116 that may in turn involve employer paid services 1118 or insurance paid claims 1120. Alternatively, the electronic medical records 1114 may be used in connection with payment for general healthcare services 1122 that may in turn involve medicare 1124, capitation 1126, indemnity 1128 or cash 1130. Alternatively, the electronic medical records 1114 may be used in connection with payment for other services 1132 such clinical trials 1112 and personal injury liens 1110.

In general, the various payment types discussed above result in billings 34 that in turn create accounts receivables. An exception to this may be personal injury liens 1110 that result in receivable financing 1136. In any event, billing 1134 may involve medical practice management systems 1138 that result in collections 1140 on the account receivables. The medical practice management systems 1138 may also involve physician/clinic performance reports 1142 and physician/clinic financial reports 1144.

Collections 1140 may comprise a part of gross cash reimbursements from which the physician/clinic 26 may derive income 1144. The physician's income 1144 may be a portion of gross cash reimbursements 1142 in light of the fact that coordinator 6 may derive a income 1146 as a percent of gross cash receipts, a subscription fee, a network contact or a factoring fee.

k. Software Structure

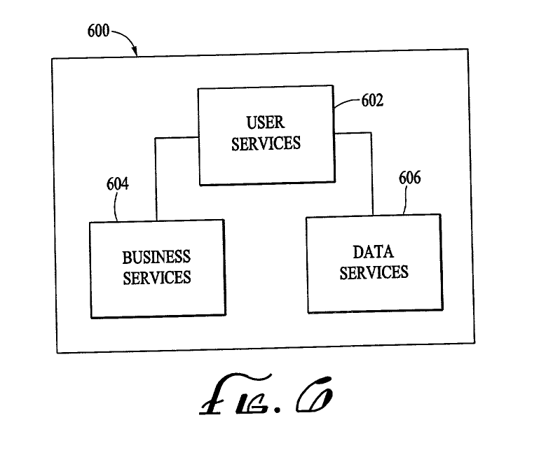

Referring now to FIG. 6, a preferred embodiment of a software structure 600 of the software 10 of FIG. 1 is now described. The software is preferably located in or associated with central database 18 and may be partitioned into three logical tiers: user services 602, business services 604, and data services 606. This structure is preferred for scalability and flexibility purposes.

The user services tier 602 may comprise the software that provides the visual and/or graphical interfaces that a user views when accessing system 5. For example, user services tier 602 may provide various forms that are displayed on a user's computer and that provide fields for data entry, such as when a patient's electronic medical records is created or updated. As another example, user services tier 602 may provide the various reports discussed above.

It is preferred that the software of user services tier 602 provides visual formats to the user that are easily understood and easily used, whether it be forms that are easily filled out or reports that are easily read and understood. This ease of use renders system 5 more effective and preferably leads to an increase in use by existing and prospective users. This in turn preferably results in an increase in the data stored in database 22 and an increase in revenue generation.

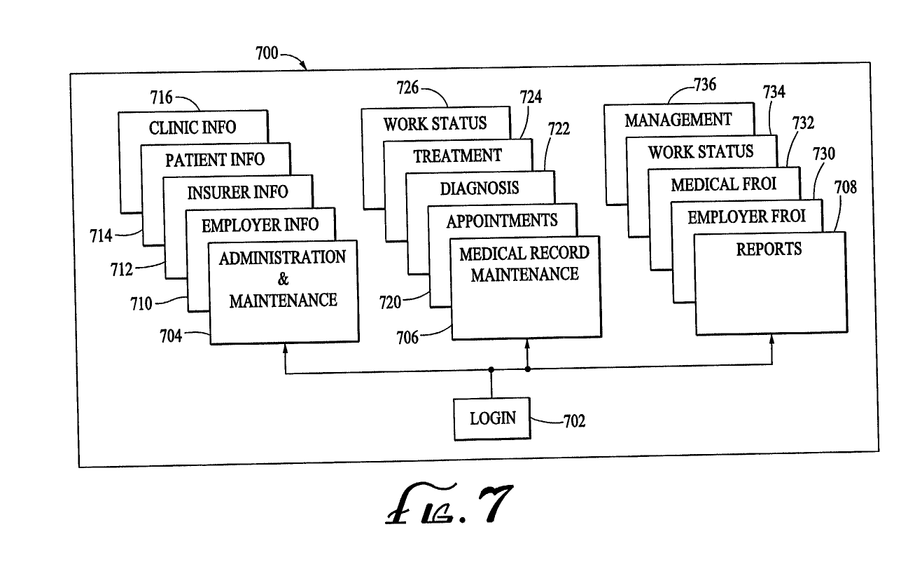

A sample design of the user interface 700 provided by the user services tier software 602 is shown in FIG. 7. As shown, the user may first be presented with a login interface 702. This may comprise a field on the home (or other) page of web site 12 in which the user enters its login password. After logging in, the user may then be presented with three main user interfaces, i.e., administration & maintenance 704, medical record maintenance 706 and reports 708. Each of these may comprise an icon on the coordinator's web site 12 that the user may click on to access. Upon doing so, the user may then be presented with other interfaces that are for receiving data and/or that may provide data.

Administration & maintenance 704 interface may comprise additional interfaces or folders as shown. Once in interface 704, the folders contained therein may appear as icons on the user's computer screen and which the user may click on to access. For example, administration & maintenance interface 704 may include employer information interface 710, insurance company information interface 712, patient information interface 714 and clinic/physician information interface 716. Other folders may also be included. Each of the interfaces or folders preferably comprises a format which is easy to understand so that data about the particular entity may be readily input or reviewed.

Medical record maintenance interface 706 may comprise additional interfaces are folders such as appointments 720, diagnosis 722, treatment 724 and work status 726. Other folders may also be included. These folders generally represent the electronic medical records discussed earlier, and as such, may be used to input information on the patient and his or her treatment and progress through a worker's compensation claim. This information may be stored in patient record database 20. As noted above, when these records are revised to reflect updated information, it is preferred that the old or existing record not be deleted from system 5. Instead, the existing record is preferably updated by creating a new version of this record. In this manner, a patient's history may readily be accessed.

Reports interface 708 may include additional interfaces or folders such as employer FROI 730, medical FROI 732, work status 734 and management 736. Each of these interfaces may provide a user with access to a particular type of report such as those discussed above. It is preferred that certain folders may only be accessed by users having the appropriate password or other type of security clearance. It is also preferred that the reports have an easy to review format so that the reports may be easily understood and put to practical use.

Referring back to FIG. 6, the software of user services tier 602 preferably interfaces with the software of business services tier 604 and data services tier 606 to provide authorized users with access to the services and functionality provided by those tiers 604, 606. The software of these tiers is now further discussed.

Business services tier 604 preferably comprises components that define the business model for a given user of system 5, i.e., the rules under which the user operates. For example, the business model of a particular user employer 24 may specify that for a given type of injury and after a certain amount of treatment, the patient 30 should be fit to return to work. So, for example, according to the business model of this employer 24, after a certain amount of treatment has occurred for a certain injury, system 5 may issue a “back to work order”.

In practice, the rules under which companies operate frequently change making it necessary to rewrite business models. Thus, the components of the business services tier 604 are designed so that they may be modified and adapted to meet the requirements of an updated business model without affecting components in the data services tier 606 or the overall software 10. As a result, flexibility is provided by software 10 to respond to an ever-changing business environment without having to redesign the entire software structure 600.

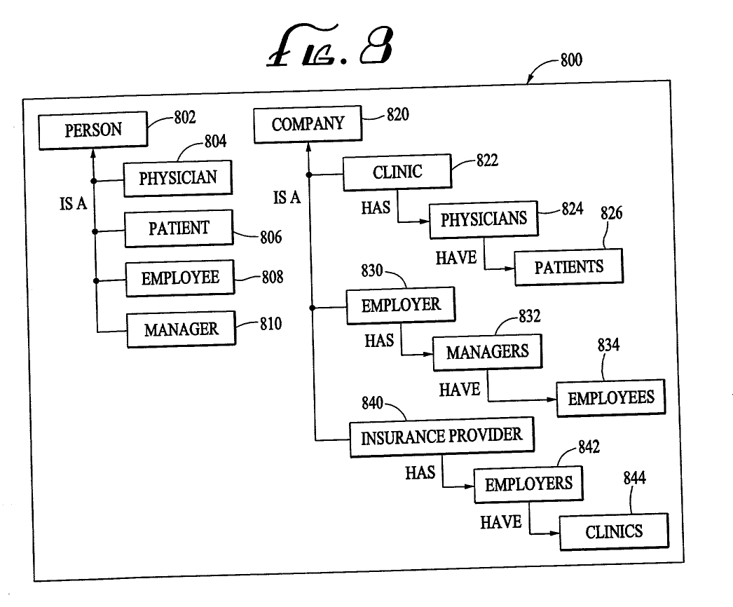

The components of the business services tier 604 may contain all of a business' objects, relations, processes and operating rules that represent its business model. This is illustrated in FIG. 8 which shows a sample listing of a user's business model 800. For example, a person 802 about which information is contained in system 5 may be categorized as a physician 804, patient 806, employee 808 or manager 810. Furthermore, each person may be considered a business object that has such attributes as name, age and job function. Information reflecting these attributes may be entered into system 5 for use by software 10.

Employee 30 may be related to other business objects such as employer 28, which also has specific attributes and processes. It is very common for employees in the business world, such as employee 30, to leave their jobs or to be fired, thus changing the makeup of a business. Accordingly, it is advantageous to have the business services tier 604 separate from the data services tier 606 so that modifications necessitated by changes in a business environment may be made without affecting the rest of the software 10.

Referring again to FIG. 8, the sample business model 800 may also specify information and the relations about users of system 5. For example, company 820 may comprise a clinic 822 that has physicians 824 that have patients 826. As another example, company 820 may comprise an employer 830 that has managers 832 that in turn have employees 834. As another example, company 820 may comprise an insurance provider 840 that has, i.e., insures, employers 842 that have, i.e., are associated with, clinics 844.

The data services tier 606 may comprise software that allows authorized users to retrieve and modify data at the web site 12. The data services tier 606 and the business services tier 604 preferably operate independently from one another. Thus, the components of the data services tier 606 may accept inputted data without affecting the components of the business services tier 604.

The data services tier 606 may generally comprise a relational database into which information is input and that allows this information to be manipulated and reported in various formats. FIG. 9 shows a sample relational database 900 containing various tables and fields. It is preferred that the tables generally contain identification codes to allow them to be related to each other as information is manipulated for reporting purposes. The information input into the fields of the table in database 900 may generally be alphanumeric, but may also be in a text format.

In the worker's compensation example, database 900 may include a physician table 902 that may include fields 902a for an identification code for a particular physician and 902 for other identifying information. Physician's specialty table 904 may include field 904a to identify the specialty per a certain identification code. Database 900 may also include physician provider table 906.

Database 900 may also include a provider table 908 that includes various fields containing the name 908a, address 908b and other contact information of the provider. Location table 910 may contain various fields for contact information and other identifying information. Incident table 911 may include an incident identification code field 911a, as well as other fields for information on the incident giving rise to the worker's compensation claim and the physician that will be treating the patient. Provider assign table 912 may include a worker's compensation claim identification field 912a as well as fields for other information regarding a provider.

Appointment table 914 may include appointment identification field 914a, as well as fields for other identification codes as shown. Textual comments may be entered into the “comments” field. Representation table 916 may include an identification field 916a and a field for the associated description. Appointment type table 918 may include an identification code field and fields for other information pertinent to the type of appointment. Provider group table 919 may provide information regarding provider groups.

Care table 920 may include an identification code field 920a, as well as other information about the incident giving rise to the worker's compensation claim. Care type table 922 may provide information about the type of care, and diagnosis table 924 may include fields for identifying the type of care 924a and the diagnosis 924b. To this end, physician 26 may enter a certain code to identify his or her diagnosis of the patient's injury or other ailment. Database 900 may also include ICD table 925.

Treatment table 926 may include fields to identify the type of treatment planned. In connection with the quality control aspect of the current invention, the treatment identification code may be compared against the diagnosis identification code to determine whether there is a deviation from the list of pre-approved treatment protocols. Database 900 may also include CPT table 928 and Supplemental CPT table 930, provider group table 932 and employer provider group table 934. Database 900 may also include treatment plan detail table 936 in which information describing details on the patient's treatment may be input.

The various tables in database 900 may be connected, i.e., related to each other, as shown. However, it should be noted that additional tables and/or fields may be contained in database 900. Furthermore, the tables in database 900 may be connected other than as shown in FIG. 9.

While a preferred embodiment of the software structure of system 5 has been described, the scope of the current invention is not limited to this specific software. Variations may be made to the software structure without departing from the spirit of the present invention.

And in general, while the present invention has been set forth in the form of preferred embodiments, it will be apparent to those skilled in the art to which the invention pertains that variations and modifications of the described embodiments may be made without departing from the spirit and scope of the invention.

What is claimed is:

1. A method of managing patient records, comprising:
providing an online interface system;
creating patient medical records for a plurality of patients, the patient medical records stored in the online interface system;
providing a plurality of authorized users access to at least one of the patient medical records via a web site, consistent with predetermined access rules.

2. The method of claim 1 wherein one of the plurality of authorized users is an employer having employees.

3. The method of claim 2 wherein at least one of the plurality of patients is an employee working for the employer.

4. The method of claim 2 wherein one of the plurality of authorized users is an insurance company, the insurance company providing insurance coverage to the employer.

5. The method of claim 2 wherein one of the plurality of authorized users is a physician, the physician entering data into the online interface system corresponding to a patient encounter with at least one of the employees.

6. The method of claim 5 further comprising sending an electronic bill to at least one of an insurance company and the employer after the physician enters data into the online interface system.

7. The method of claim 1 further comprising providing the plurality of authorized users the ability to retrieve, store, and disseminate at least one of the patient encounter records at a computer terminal having Internet access.

8. The method of claim 1 wherein the patient medical records are associated with work-related injuries.

9. The method of claim 1 further comprising providing a physician access to treatment protocols stored in the online interface system, the treatment protocols corresponding to diagnoses made by the physician.

10. The method of claim 9 further comprising providing at least one of an employer and an insurance company the opportunity to pre-approve the treatment protocols before the treatment protocols are stored in the online interface system.

11. The method of claim 10 further comprising notifying electronically at least one of the employer and the insurance company whenever the physician provides treatment to a patient that does not fall within one of the treatment protocols.

12. A method of managing patient medical records, comprising:
providing an electronic interface system;
creating patient medical records associated with work-related injuries for a plurality of patients, the patient medical records stored in the electronic interface system;
providing a plurality of authorized users access to at least one of the patient medical records, consistent with predetermined access rules.

13. The method of claim 12 wherein the plurality of authorized users comprise an employer, an insurance company, a physician, and an employee employed by the employer.

14. The method of claim 12 further comprising providing the plurality of authorized users access to the electronic interface system online via a web site.

15. The method of claim 14 further comprising providing the plurality of authorized users the ability to retrieve, store, and disseminate at least one of the patient medical records at a computer terminal having Internet access.

16. The method of claim 12 further comprising providing a physician access to treatment protocols stored in the electronic interface system, the treatment protocols corresponding to diagnoses made by the physician.

17. The method of claim 16 further comprising providing at least one of an employer and an insurance company the opportunity to pre-approve the treatment protocols before the treatment protocols are stored in the electronic interface system.

18. The method of claim 17 further comprising notifying electronically at least one of the employer and the insurance company whenever the physician provides treatment to a patient that does not fall within one of the treatment protocols.

19. A method of managing patient medical records, comprising:
providing an online interface system;
creating patient medical records for a plurality of patients, the patient medical records stored in the online interface system;
providing a plurality of authorized users access to at least one of the patient encounter records via a web site, consistent with predetermined access rules;
providing a physician access to treatment protocols stored in the online interface system, the treatment protocols corresponding to diagnoses made by the physician.

20. The method of claim 19 further comprising providing at least one of an employer and an insurance company the opportunity to pre-approve the treatment protocols before the treatment protocols are stored in the online interface system.

21. The method of claim 20 further comprising notifying electronically at least one of the employer and the insurance company whenever the physician provides treatment to a patient that does not fall within one of the treatment protocols.

22. The method of claim 19 wherein the plurality of authorized users comprise an employer, an insurance company, a physician, and an employee employed by the employer.

23. An online patient record system, comprising:
a database located at a web site, the database comprising
a first set of components facilitating the viewing and entering of patient data at the web site by a plurality of authorized users;
a second set of components electronically linked to the first set of components, the second set of components defining a business model for a business;
a third set of components electronically linked to the first set of components, the third set of components facilitating the retrieval and modification of patient data at the web site by the plurality of authorized users, the third set of components operatively independent from the second set of components.

24. The online patient record system of claim 23 wherein the plurality of authorized users comprise an employer, an insurance company, a physician, and an employee employed by the employer.

25. The online patient record system of claim 24 wherein the patient data comprises work-related injury information associated with the employee.

26. The online patient record system of claim 23 wherein the second set of components is modifiable and adaptable to meet the requirements of an updated business model without affecting the third set of components.

27. The online patient record system of claim 23 wherein the third set of components is adapted to accept inputted data without affecting the second set of components.

28. The online patient record system of claim 23 wherein the third set of components comprises treatment protocols corresponding to diagnoses made by physicians.

29. The online patient record system of claim 23 wherein the second set of components and the third set of components are accessed by the plurality of authorized users via the first set of components.

30. The online patient record system of claim 23 wherein the database is accessible to the plurality of authorized users from any computer terminal having Internet access.
